(19) United States
(12) Patent Application Publication
(10) Pub. No.: US 2013/0279538 A1
(43) Pub. Date: Oct. 24, 2013

(54) Thermal Sensor Having a Coupling Layer, and a Thermal Imaging System Including the Same

(71) Applicant: Bridge Semiconductor Corporation, (US)

(72) Inventors: Howard Beratan, Forest Hills, PA (US); Pilyeon Park, Santa Clara, CA (US); Smitha Shetty, State College, PA (US); Chien Hung Wu, Strongsville, OH (US)

(21) Appl. No.: 13/860,137

(22) Filed: Apr. 10, 2013

Related U.S. Application Data
(60) Provisional application No. 61/622,058, filed on Apr. 10, 2012.

(51) Int. Cl. G01K 1/16

(52) U.S. Cl. CPC G01K 1/16
USPC 374/165

(57) ABSTRACT

A thermal sensor includes a first semi-transparent electrode; a second electrode; a thermally sensitive element positioned between the first and second electrodes; and a coupling layer positioned between the first electrode and the thermally sensitive element, wherein the thermally sensitive element is in electrical communication with the first electrode via the coupling layer and is in electrical communication with the second electrode. An optional second coupling layer may be positioned between the second electrode and the thermally sensitive element, wherein the thermally sensitive element is in electrical communication with the second electrode via the second coupling layer.

### CROSS REFERENCE TO RELATED APPLICATION

This application claims priority from U.S. Provisional Patent Application No. 61/622,058, filed Apr. 10, 2012, which is incorporated herein by reference.

### BACKGROUND OF THE INVENTION

1. Field of the Invention

This application relates to a thermal sensor having a coupling layer and a thermal imaging system including the same.

2. Description of Related Art

In various infrared or thermal imaging systems, thermal sensors are used to detect infrared radiation (e.g., radiation in the 7 μm to 14 μm band) and generate an image suitable for viewing by the human eye. Such systems detect small thermal radiation differences emitted by objects in a scene and convert the differences into electrical charges which tend to be extremely small. The electrical charges are then processed and stored for additional processing, use, and/or analysis, such as by a robotics application, or communicated to a display device which displays a representation of the scene. Such processing may include amplification, noise-correction, filtering, etc.

Some thermal imaging systems rely on a thermal sensor that includes a pyroelectric layer sandwiched between two electrodes to determine the thermal radiation differences emitted by the objects in a scene. Production of large-area, thin film pyroelectric layers is now possible with the use of the coupling layers of the invention.

### SUMMARY OF THE INVENTION

Disclosed herein is a thermal sensor, comprising: a first semi-transparent electrode; a second electrode; a thermally sensitive element positioned between the first and second electrodes; and a coupling layer positioned between the first electrode and the thermally sensitive element, wherein the thermally sensitive element is in electrical communication with the first electrode via the coupling layer and the second electrode.

The first electrode can be a thin film electrode. The first electrode can comprise lanthanum nickelate.

The second electrode can be a thin film electrode. The second electrode can be reflective. The second electrode can comprise gold and at least one of chromium or TiW, and wherein chromium or TiW is positioned between the gold and the thermally sensitive element.

The thermally sensitive element can comprise a pyroelectric material. The pyroelectric material can comprise lead zirconate titanate, manganese doped lead zirconate titanate, or lead lanthanum zirconate titanate.

The coupling layer can be in direct contact with at least one of: the thermally sensitive element or the first electrode. The coupling layer can comprise an oxide. The oxide can comprise one of: titanium dioxide; zirconium oxide; or cerium oxide. The oxide can comprise a compound oxide. The compound oxide can comprise one of: strontium titanium oxide; or cerium zirconium oxide.

The coupling layer can have a thickness between one of the following: about 50 Angstroms to about 1000 Angstroms in thickness; about 150 Angstroms to about 800 Angstroms; or between about 300 Angstroms to about 500 Angstroms.

Also disclosed herein is a thermal sensor, comprising: a first semi-transparent electrode; a second electrode; a thermally sensitive element positioned between the first and second electrodes; and a first coupling layer positioned between the first electrode and the thermally sensitive element; and a second coupling layer positioned between the thermally sensitive element and the second electrode, wherein the thermally sensitive element is in electrical communication with the first electrode via the first coupling layer and the second electrode via the second coupling layer.

The second coupling layer can be in direct contact with at least one of the following: the thermally sensitive element; and the second electrode. The second coupling layer can comprise an oxide. The oxide can comprise one of: titanium dioxide; zirconium oxide; or cerium oxide. The oxide can comprise a compound oxide. The compound oxide can comprise one of the following: strontium titanium oxide; and cerium zirconium oxide.

The second coupling layer can have a thickness between one of the following: about 50 Angstroms to about 1000 Angstroms; about 150 Angstroms to about 800 Angstroms; or about 300 Angstroms to about 500 Angstroms.

Also disclosed herein is a thermal sensor, comprising: a first electrode; a second electrode; a thermally sensitive element positioned between the first and second electrodes; a coupling layer positioned between the first electrode and the thermally sensitive element; a first arm member extending from and in electrical communication with the first electrode; a second arm member extending from and in electrical communication with the second electrode; a first support member in electrical communication with the first arm member; and a second support member in electrical communication with the second arm member, wherein the thermally sensitive element is in electrical communication with the first electrode via the coupling layer; and the second electrode.

Also disclosed herein is a thermal sensor, comprising: a first electrode; a second electrode; a thermally sensitive element positioned between the first and second electrodes; a first coupling layer positioned between the first electrode and the thermally sensitive element; a second coupling layer positioned between the second electrode and the thermally sensitive element; a first arm member extending from and in electrical communication with the first electrode; a second arm member extending from and in electrical communication with the second electrode; a first support member in electrical communication with the first arm member; and a second support member in electrical communication with the second arm member, wherein the thermally sensitive element is in electrical communication with the first electrode via the first coupling layer and the second electrode via the second coupling layer.

Also disclosed herein is a thermal imaging system, comprising: a readout circuit; and a thermal sensor in electrical communication with the readout circuit, wherein the thermal sensor comprises: a first electrode; a second electrode; a thermally sensitive element positioned between the first and second electrodes; and a coupling layer positioned between the first electrode and the thermally sensitive element, wherein the thermally sensitive element is in electrical communication with the first electrode via the coupling layer and the second electrode.

The thermal imaging system can further comprise a second coupling layer positioned between the second electrode and the thermally sensitive element, wherein the thermally sensitive element is in electrical communication with the second electrode via the second coupling layer.

Also disclosed herein is a microelectronic structure having a bottom electrode 24, a semi-transparent top electrode 22, a thermally sensitive pyroelectric layer 26, and at least one coupling layer 28 between the pyroelectric layer 26 and the top electrode 28, and optionally, an additional coupling layer 42 between the pyroelectric layer 26 and the bottom electrode 24, wherein the microelectronic structure is between 0.2 and 500 square centimeters in size.

Lastly, disclosed herein is a method of reducing current leakage over a large-area thin film structure, the method comprising the steps of: providing a substrate; depositing a first electrode, wherein the first electrode is comprised of a transparent oxide; depositing a coupling layer on top of the first electrode; depositing a thermally sensitive layer on top of the coupling layer; depositing a second electrode on top of the thermally sensitive layer; patterning and etching the second electrode; and poling the structure, wherein the structure is between about 0.2 and 40 square centimeters in size.

### BRIEF DESCRIPTION OF THE DRAWINGS

FIG. 1 is a high-level block diagram of a thermal imaging system;

FIG. 2 is a schematic drawing of a first embodiment thermal sensor for use in the thermal imaging system of FIG. 1;

FIG. 3 is a schematic drawing of a second embodiment thermal sensor for use in the thermal imaging system of FIG. 1; and

FIG. 4 is a schematic drawing of a thermal imaging system including the second embodiment thermal sensor of FIG. 3.

### DETAILED DESCRIPTION OF THE INVENTION

As used herein in the specification and claims, including as used in the examples, and unless otherwise expressly specified, all numbers may be read as if prefaced by the word “about”, even if the term does not expressly appear. Also, any numerical range recited herein is intended to include all sub-ranges subsumed therein.

As used herein, the term “in electrical communication with” means any type of electrical communication, including, for example, resistive coupling or capacitive coupling.

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

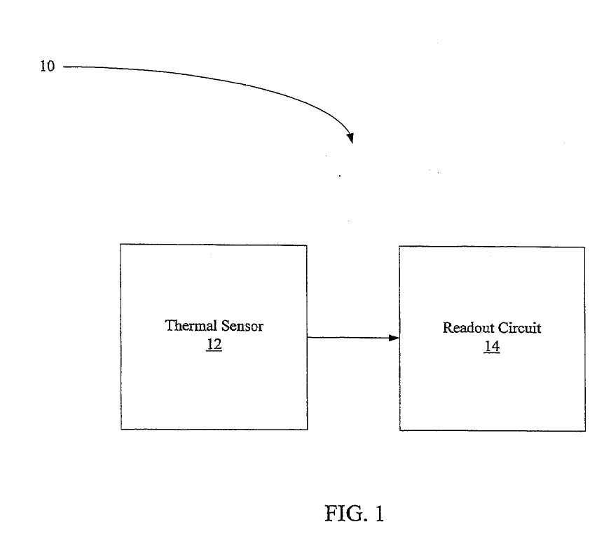

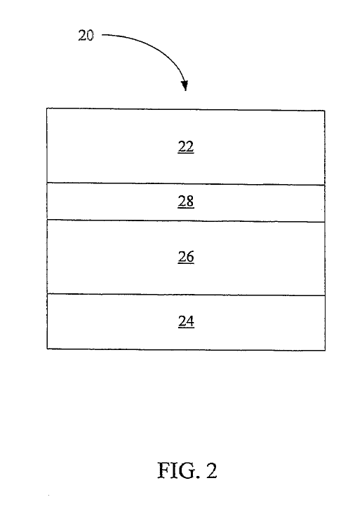

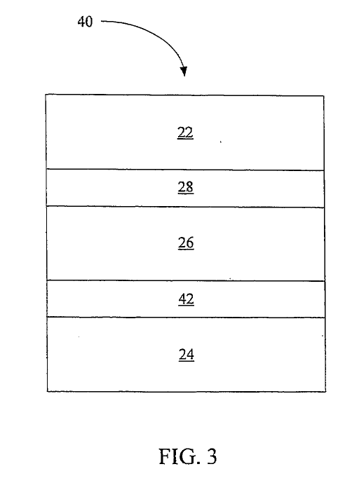

FIG. 1 illustrates a high-level representation of a thermal imaging system 10. The thermal imaging system 10 may be used to thermally capture a scene and store the thermal data or generate an image that is representative of the scene and suitable for viewing by the human eye. In some embodiments, the thermal imaging system 10 includes a thermal sensor 12, and a readout circuit 14 in electrical communication with the thermal sensor 12. It will be appreciated that the thermal imaging system 10 may include other components commonly included in a thermal imaging system such as, for example, a lens assembly, a chopper, a power supply, a display device, etc. Although only one thermal sensor 12 and one readout circuit 14 are shown in FIG. 1, it will be appreciated that the thermal imaging system 10 may include a plurality of thermal sensors 12 and a plurality of sensor-level circuits in a readout circuit 12. Each thermal sensor 12 may be considered to be an individual pixel, and will be described in more detail herein below with respect to FIGS. 2 and 3.

The readout circuit 14 is in electrical communication with the thermal sensor 12 and is configured to process electric signals received from the thermal sensor 12. Such processing may include, for example, amplification of a received signal which is representative of a captured scene, and conversion of the amplified signal into a digital signal. In some embodiments, processing includes conversion of the digital signal into an analog video signal. When the video signal is communicated to a display device, the display device displays a representation of the captured scene. The readout circuit 14 may be any suitable type of readout circuit 14.

FIG. 2 illustrates a thermal sensor 20 according to one embodiment. The thermal sensor 20 includes a first electrode 22, a second electrode 24, a thermally sensitive element 26 and a coupling layer 28.

The first electrode 22 may be fabricated from any suitable electrically conductive material. For example, in some embodiments, the first electrode 22 is substantially transparent to thermal radiation and includes a layer of lanthanum nickelate (LaNiO3 or LNO). In other embodiments, the first electrode 22 may comprise other types of semi-transparent electrically conductive materials. Desirably, the semi-transparent electrically conductive materials are conductive oxides. Semi-Transparent conductive oxides (STCO) such as indium-tin-oxide (ITO), Al-doped zinc oxide (AZO), Zn-doped indium oxide (IZO), LaSrCoO3 (LSCO), LaSrMnO3 (LSMO), (Sr1-x,Bax)Ru03 (SRO), and iridium oxide (IrO2) can also be used.

The first electrode 22 may be fabricated in any suitable size and configuration. In some embodiments, the first electrode 22 is a thin film electrode, between 50 Å and 2000 Å in thickness.

The second electrode 24 may be fabricated from any suitable electrically conductive material. In some embodiments, the second electrode 24 is not transparent and is reflective, and includes a layer of gold, and may also include a layer of chromium or TiW, both of which function as a “glue.” In other embodiments, the second electrode 24 may include other types of electrically conductive reflective materials such as NiCr, Al, Cu, TiAl, Ni, Pt, Pd, Ag, Cr, Ta, or combinations of any of these, including combinations with gold and chromium, and gold and TiW.

The second electrode 24 may be fabricated in any suitable size and configuration. In some embodiments, the second electrode 24 is a thin film electrode comprised of two layers, a layer of gold and a layer of chromium or TiW, where the thickness of the gold layer is between 50 Å and 10000 Å and the thickness of the chromium or TiW layer is between 50 Å to 500 Å. In some embodiments, the second electrode 24 is substantially transparent to thermal radiation, and can be prepared from any suitable semi-transparent electrically conductive material, such as the semi-transparent electrically conductive materials described above for the first electrode, as well as thin film metals or metal alloys such as NiCr or TiAl.

The thermally sensitive element 26 is positioned between the first and second electrodes 22, 24. In some embodiments, the thermally sensitive element 26 is in direct contact with the second electrode 24. For embodiments where the second electrode 24 includes a layer of gold and a layer of chromium or TiW, the layer of chromium or TiW is positioned between the thermally sensitive element 26 and the layer of gold.

The thermally sensitive element 26 may be fabricated from any suitable thermally sensitive material. In some embodiments, the thermally sensitive element 26 includes a pyroelectric material such as a lead-based pyroelectric material including lead zirconate titanate (PZT), lead strontium titanate (PST), lanthanum doped lead zirconate titanate (PLZT), manganese doped lead zirconate titanate (PMZT), manganese doped lead lanthanum zirconate titanate (Mn:PLZT), 0.75Pb (Mg1/3-Nb2/3)03-0.25PbTiO3 (PMN-PT), Mg2+, Ca2+, Sr2+, Ba2+ doped lead zirconate titanate (e.g. Mg-PZT), lead calcium titanate PCT. Other suitable pyroelectric materials can also be used. Non-limiting examples of these include lithium-based materials such as lithium tantalate (LiTaO3) and doped lithium tantalates; and barium-based materials such as barium strontium titanate (BST) and barium strontium calcium titanate. Doped versions of any of the above, as well as analogues of any of the above, can also be used.

The thermally sensitive element 26 may be fabricated in any suitable size and configuration. For example, in some embodiments, thermally sensitive element 26 has a thickness of about 500 Angstroms to 2 microns. Bulk materials forming thermally sensitive element 26 may be thinned to about 10 μm by polishing, and to about 1 or 2 μm by ion milling or reactive ion etching.

A coupling layer 28 is positioned between the first electrode 22 and the thermally sensitive element 26. In some embodiments, the coupling layer 28 is in direct contact with the first electrode 22 and/or the thermally sensitive element 26. The coupling layer 28 may be fabricated from any suitable material having a dielectric constant between 5 and 150. In some embodiments the dielectric constant is greater than about 25, for example, for a 50 Angstroms thick coupling layer. In some embodiments, coupling layer 28 is fabricated from an oxide. In some embodiments, the oxide is a simple oxide such as, for example, titanium dioxide (TiOx), zirconium oxide (ZrOx), and cerium oxide (CeOx). In other embodiments, the oxide may be a compound oxide such as, for example, strontium titanium oxide (SrTiOx), or cerium zirconium oxide (CeZrOx).

The coupling layer 28 may be fabricated in any suitable size and configuration. In some embodiments, the thickness of the coupling layer 28 is in the range from about 50 Angstroms to about 1000 Angstroms. According to other embodiments, the thickness of the coupling layer 28 ranges from about 150 Angstroms to about 800 Angstroms. In yet other embodiments, the thickness of the coupling layer 28 ranges from about 300 Angstroms to about 500 Angstroms.

With the thermal sensor 20 shown in FIG. 2, the thermally sensitive element 26 is in electrical communication with the second electrode 24, and is also in electrical communication with the first electrode 22 via the coupling layer 28. As explained in more detail herein below, the inclusion of the coupling layer 28 enhances the poling yield (i.e., reduces the electrical leakage between first electrode 22 and second electrode 24 through thermally sensitive element 26) by limiting and/or preventing interaction between the first electrode 22 and the thermally sensitive element 26 during poling. The coupling layer 28 may also prevent interaction between the top electrode 22 and bottom electrode 24 through flaws in the material.

FIG. 3 illustrates a thermal sensor 40 according to another embodiment. Thermal sensor 40 is similar to the thermal sensor 20 of FIG. 2 in that thermal sensor 40 includes first electrode 22, second electrode 24, thermally sensitive element 26 and coupling layer 28 as described hereinabove, but is different in that thermal sensor 40 also includes a second coupling layer 42 between second electrode 24 and thermally sensitive element 26.

For embodiments where the second electrode 24 includes a layer of gold and a layer of chromium or TiW, the second coupling layer 42 is positioned between the thermally sensitive element 26 and the layer of chromium/TiW. In some embodiments, the second coupling layer 42 is in direct contact with the second electrode 24 and/or the thermally sensitive element 26.

The second coupling layer 42 may be fabricated from any suitable material. In some embodiments, the second coupling layer 42 is fabricated from an oxide. In some embodiments, the oxide is a simple oxide such as, for example, titanium dioxide (TiOx), zirconium oxide (ZrOx), or cerium oxide (CeOx). According to other embodiments, the oxide may be a compound oxide such as, for example, strontium titanium oxide (SrTiOx) or cerium zirconium oxide (CeZrOx). The second coupling layer can be the same as the first coupling layer, or it can be different.

The second coupling layer 42 may be fabricated in any suitable size and configuration. In some embodiments, the thickness of the second coupling layer 42 is in the range from about 50 Angstroms to about 1000 Angstroms. In other embodiments, the thickness of the second coupling layer 42 ranges from about 150 Angstroms to about 800 Angstroms. According to yet other embodiments, the thickness of the coupling layer 42 ranges from about 300 Angstroms to about 500 Angstroms.

With the thermal sensor 40 shown in FIG. 3, the thermally sensitive element 26 is in electrical communication with the first electrode 22 via the coupling layer 28, and is in electrical communication with the second electrode 24 via the second coupling layer 42. As explained in more detail herein below, the inclusion of the second coupling layer 42 further enhances the poling yield (i.e., reduces the electrical leakage between the second electrode 24 and the thermally sensitive element 26) by limiting and/or preventing interaction between the second electrode 24 and the thermally sensitive element 26 during poling.

In additional embodiments, the invention provides a microelectronic structure, as illustrated in FIGS. 2 and 3, the microelectronic structure having a bottom electrode 24, a top electrode 22, a thermally sensitive pyroelectric layer 26, and at least one coupling layer 28 between the pyroelectric layer 26 and the top electrode 28. Optionally, the microelectronic structure comprises an additional coupling layer 42 between the pyroelectric layer 26 and the bottom electrode 24.

Microelectronic structures according to the invention are between 0.2 square centimeters and 10 square centimeters in size, and in some cases up to 20, 25, 30, 35 or 40 square centimeters in size, even as large as 100, 200, 300, 400 or 500 square centimeters in size.

The coupling layer 28 or coupling layers 28, 42 of the microelectronic structure are as described above, i.e., fabricated from a simple oxide such as titanium dioxide (TiOx), zirconium oxide (ZrOx), or cerium oxide (CeOx), or a compound oxide such as, for example, strontium titanium oxide (SrTiOx) or cerium zirconium oxide (CeZrOx). The coupling layer 28 can be the same as coupling layer 42, when present, or it can be different. The coupling layer 28 or coupling layers 28, 42, are about 50 Angstroms to about 1000 Angstroms in thickness.

The top electrode 22, bottom electrode 24, and thermally sensitive materials 26 are comprised of the same materials as described above for the top and bottom electrodes and the thermally sensitive layer of the thermal sensor.

In additional embodiments, the invention provides a method of reducing current leakage over a large-area thin film structure. The method comprises the steps of: providing a substrate; depositing a first electrode 22, wherein the first electrode is comprised of a semi-transparent electrically conductive layer; depositing a coupling layer 28 on top of the first electrode 22; depositing a thermally sensitive layer 26 on top of the coupling layer; depositing a second electrode 24 on top of the thermally sensitive layer; patterning and etching the second electrode; and poling the structure, wherein the structure is between about 0.2 and 500 square centimeters in size.

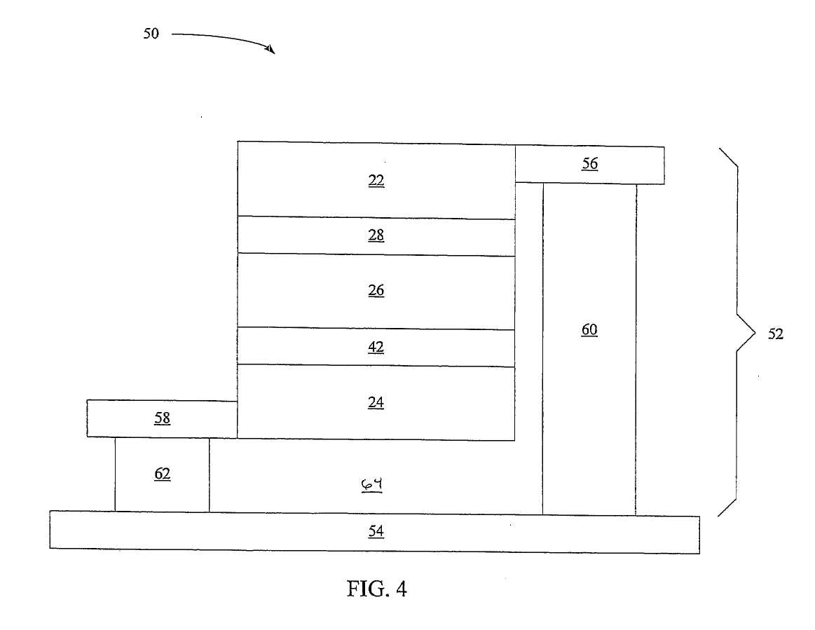

FIG. 4 illustrates certain embodiments of a thermal imaging system 50. The thermal imaging system 50 includes a thermal sensor 52 mounted to a substrate 54. In some embodiments, the thermal sensor 20 of FIG. 2 forms a portion of the thermal sensor 52. In other embodiments, the thermal sensor 40 of FIG. 3 forms a portion of the thermal sensor 52. Thus, it will be appreciated that the thermal sensor 52 includes a first electrode 22, a second electrode 24, a thermally sensitive element 26, and a coupling layer 28 as described hereinabove. It will also be appreciated that the thermal sensor 52 may also include a second coupling layer 42 as described hereinabove. In addition to the above-described components, the thermal sensor 52 also includes a first electrically conductive arm member 56, a second electrically conductive arm member 58, a first electrically conductive support member 60 and a second electrically conductive support member 62. In some embodiments, arm members 56, 58 can also serve the function of the support members, 60, 62. Although only one thermal sensor 52 is shown as being connected to the substrate 54 in FIG. 4, it will be appreciated that the thermal imaging system 50 may include a plurality of thermal sensors 52 connected to the substrate 54.

The substrate 54 may be any suitable type of substrate. In some embodiments, the substrate 54 is an integrated circuit substrate which includes the necessary electrical couplings (e.g., contact pads) and circuitry (e.g., readout circuits 14 as described hereinabove) to process the thermal image detected by each thermal sensor 52 coupled thereto. The electrical couplings are in electrical communication with the circuitry. However, for purposes of simplicity, the electrical couplings and circuitry are not shown in FIG. 4.

The first arm member 56 is in electrical communication with the first electrode 22. The first arm member 56 may be fabricated from any suitable electrically conductive material. For example, in some embodiments, the first aim member 56 is fabricated from the same type of material as the first electrode 22. In other embodiments, the first arm member 56 may be fabricated from a different type of electrically conductive material such as TiAl, TiNi, NiCr, LNO, LaSrCoO3(LSCO), indium-tin-oxide (ITO), Al-doped zinc oxide (AZO), Zn-doped indium oxide (IZO), LaSrMnO3 (LSMO), SrRu03 (SRO,), or iridium oxide (IrO2), for example.

The second arm member 58 is in electrical communication with the second electrode 24. The second arm member 58 may be fabricated from any suitable electrically conductive material. In some embodiments, the second arm member 58 is fabricated from the same type of material as the second electrode 24. In other embodiments, the second arm member 58 may be fabricated from a different type of electrically conductive material such as, for example TiAl, TiNi, NiCr, LNO, LaSrCoO3(LSCO), indium-tin-oxide (ITO), Al-doped zinc oxide (AZO), Zn-doped indium oxide (IZO), LaSrMnO3 (LSMO), (Sr1-x,Bax)Ru03 (SRO), or iridium oxide (IrO2).

Both the first and second arm members 56, 58 may also be fabricated from composite materials, or as multi-layer elements, as would be understood by one skilled in the art.

The first and second arm members 56, 58 may be fabricated in any suitable size and shape. The length, width and thickness of the first and second arms 56, 58 may be sized to enhance their resistance to the transfer of thermal energy between the thermal sensor 52 and the substrate 54. In some embodiments, the thickness of the first arm member 56 may be varied to control the thermal conductance between the first electrode 22 and the substrate 54. Similarly, the thickness of the second arm member 58 may be varied to control the thermal conductance between the second electrode 24 and the substrate 54.

The first support member 60 is in electrical communication with the substrate 54 (i.e., a first contact pad of the substrate 54), the first support arm member 56, and by extension, with the first electrode 22. The first support member 60 may be fabricated from any suitable electrically conductive material. In some embodiments, the first support member 60 comprises a polymer such as SU8 or polyamide, or an Si-based material such as SiO2 or Si3N4. The first support member 60 may be fabricated in any suitable size and configuration. In some embodiments, the first support member 60 is cylindrically-shaped. In some embodiments, the first support member 60 is fabricated from the same material as the first arm 56.

The second support member 62 is in electrical communication with the substrate 54 (i.e., a second contact pad of the substrate 54), the second support arm member 58, and by extension, with the second electrode 24. The second support member 62 may be fabricated from any suitable electrically conductive material. In some embodiments, the second support member 62 comprises a polymer such as SU8 or polyamide, or an Si-based material such as SiO2 and Si3N4. The second support member 62 may be fabricated in any suitable size and configuration.

For example, in some embodiments, the second support member 62 is cylindrically-shaped. In embodiments, the second support member 62 is fabricated from the same material as the second arm 58.

In some embodiments, the first and/or second support members 60, 62 can comprise solder materials. Suitable solder materials can be selected by one skilled in the art, based on melting temperature requirements and compatibility with other materials used.

The first and second support members 60, 62 physically support the thermal sensor 52 in a spaced relation with a surface of the substrate 54 via their respective support of the first and second arm members 56, 58. As shown in FIG. 4, the second electrode 24 and the substrate 54 collectively define a space or gap 64 therebetween. The height of the space 64 (i.e., the distance between the second electrode 24 and the substrate 54) may be varied depending on the wavelength of the thermal radiation that the thermal imaging system 50 is designed to detect. For example, in some embodiments, the height of space or gap 64 is about 2 microns. In some embodiments, for example if the second electrode is reflective, the height of space or gap 64 does not need to be controlled.

### Example

A first electrode (LNO) 22 was deposited on the substrate 54 by chemical solution deposition (sol-gel process), which was accomplished by spin coating, followed by a pyrolysis step, and completed by higher temperature annealing to form the continuous film. To achieve a certain thickness, the aforementioned steps are repeated until the desired thickness for the semi-transparent layer is reached. In this example, four layers were applied to achieve 80 nm in the first electrode layer. The coupling layer 28, titanium dioxide (TiOx) (about 50A) is deposited on first electrode 22 either directly via sputtering or by a high-temperature oxidation step right after the pure Ti metal deposition. Follow that step, a thermally sensitive layer 26 of manganese doped lead zirconate titanate (PMZT) was deposited on top of the coupling layer 28. The desired thickness of PMZT film (1 micron) was deposited by the repeated steps of spin coating, followed by a pyrolysis step and a higher temperature annealing on the top of the coupling layer 28-titanium dioxide (TiOx). Finally, the second electrode layer 24 was made by depositing a 10 nm thick film of Cr on top of the thermally sensitive layer 26, followed by a 50 nm Au film. A photolithography process was followed to pattern and etch the second electrode 24 to the size of 1.606 square centimeters to define the sensors. The connection 56 to the first electrode 22 is also created by either mechanical or chemical etching away of the second electrode 24 and thermally sensitive layer 26. The thermally sensitive layer 26 was poled by applying a voltage bias across a 1.606 square centimeter-sized area of the thermally sensitive layer between the first electrode 22 and the second electrode 24 at an elevated temperature (150C). Leakage current was measured while the voltage bias was applied. The dissipation factor, along with the capacitance of the structure formed by first electrode 22, coupling layer 28, thermally sensitive layer 26, and second electrode 24 was measured by an LCR meter after the poling step at room temperature.

Experiments were conducted to measure the electrical leakage of two configurations of thermal sensors: (1) a coupling layer 28 between the first electrode 22 and the thermally sensitive element 26, as in FIG. 2; and (2) no coupling layer between the first electrode 22 and the thermally sensitive element 26. The results are provided in the following Table 1.

TABLE 1

| | Leak current density | |
|---|---|---|
| | (A/cm2) | Dissipation Factor |
| Configuration w/coupling | 1 to 3.5e−6 | 1 to 2% |
| layer (FIG. 2) | | |
| Configuration w/o coupling | 1.5e−5 to 1.5e−4 | 5 to 25% |
| layer (not shown) | | |

Measurement is done under the voltage of 24 VAC.

The dissipation factor, also known as loss tangent, is the parameter used to evaluate the quality of the thermally sensitive ferroelectric layer 26. A large electrical dissipation factor, or loss tangent, results in high noise, which degrades sensor sensitivity.

As shown in Table 1, the electrical leakage between the first electrode 22 and the thermally sensitive element 26 for configuration 1 (with coupling layer 28) was about 10 to 100 times lower than for the configuration with no coupling layer. As also shown, the dissipation factor is 2 to 12 times lower for the configuration with coupling layer.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

The invention claimed is:

1. A thermal sensor, comprising:
a first semi-transparent electrode (22); a second electrode (24); a thermally sensitive element (26) positioned between the first and second electrodes; and
a first coupling layer (28) positioned between the first electrode (22) and the thermally sensitive element (26),
wherein the thermally sensitive element (26) is in electrical communication with the first electrode (22) via the coupling layer (22) and is in electrical communication with the second electrode.

2. The thermal sensor of claim 1, wherein the first electrode is a thin film electrode.

3. The thermal sensor of claim 1, wherein the first electrode comprises lanthanum nickelate.

4. The thermal sensor of claim 1, wherein the second electrode is a thin film electrode.

5. The thermal sensor of claim 1, wherein the second electrode is reflective.

6. The thermal sensor of claim 1, wherein the second electrode comprises gold and at least one of chromium or TiW, and wherein chromium or TiW is positioned between the gold and the thermally sensitive element.

7. The thermal sensor of claim 1, wherein the thermally sensitive element comprises a pyroelectric material.

8. The thermal sensor of claim 7, wherein the pyroelectric material comprises one of the following:
lead zirconate titanate;
manganese doped lead zirconate titanate; or
lead lanthanum zirconate titanate.

9. The thermal sensor of claim 1, wherein the first coupling layer is in direct contact with at least one of: the thermally sensitive element or the first electrode.

10. The thermal sensor of claim 1, wherein the first coupling layer comprises an oxide.

11. The thermal sensor of claim 10, wherein the oxide comprises one of the following: titanium dioxide; zirconium oxide; or cerium oxide.

12. The thermal sensor of claim 10, wherein the oxide comprises a compound oxide.

13. The thermal sensor of claim 12, wherein the compound oxide comprises one of: strontium titanium oxide; or cerium zirconium oxide.

14. The thermal sensor of claim 1, wherein the thickness of the first coupling layer is between one of the following:
about 50 Angstroms to about 1000 Angstroms;
about 150 Angstroms to about 800 Angstroms; or
about 300 Angstroms to about 500 Angstroms.

15. The thermal sensor of claim 1, further comprising:
a second coupling layer (42) positioned between the thermally sensitive element (26) and the second electrode (24),
wherein the thermally sensitive element (26) is in electrical communication with the first electrode (22) via the first coupling layer (22) and is in electrical communication with the second electrode (24) via the second coupling layer (42).

16. The thermal sensor of claim 15, wherein the second coupling layer is in direct contact with at least one of the following: the thermally sensitive element; and the second electrode.

17. The thermal sensor of claim 15, wherein the second coupling layer comprises an oxide.

18. The thermal sensor of claim 17, wherein the oxide comprises one of: titanium dioxide; zirconium oxide; or cerium oxide.

19. The thermal sensor of claim 17, wherein the oxide comprises a compound oxide.

20. The thermal sensor of claim 19, wherein the compound oxide comprises one of the following: strontium titanium oxide; and cerium zirconium oxide.

21. The thermal sensor of claim 15, wherein the thickness of the second coupling layer is between one of the following:
about 50 Angstroms to about 1000 Angstroms;
about 150 Angstroms to about 800 Angstroms; or
about 300 Angstroms to about 500 Angstroms.

22. The thermal sensor of claim 1, further comprising:
a first arm member (56) extending from and in electrical communication with the first electrode (22);
a second arm member (58) extending from and in electrical communication with the second electrode (24);
a first support member (60) in electrical communication with the first arm member (56); and
a second support member (62) in electrical communication with the second arm member (58).

23. The thermal sensor of claim 15, further comprising:
a first arm member (56) extending from and in electrical communication with the first electrode (22);
a second arm member (58) extending from and in electrical communication with the second electrode (24);
a first support member (60) in electrical communication with the first arm member (56); and
a second support member (62) in electrical communication with the second arm member (58).

24. A thermal imaging system, comprising:
a readout circuit; and
a thermal sensor in electrical communication with the readout circuit, wherein the thermal sensor comprises:
a first electrode;
a second electrode;
a thermally sensitive element positioned between the first and second electrodes; and
a first coupling layer positioned between the first electrode and the thermally sensitive element,
wherein the thermally sensitive element is in electrical communication with the first electrode via the coupling layer and is in electrical communication with the second electrode.

25. The thermal imaging system of claim 24, further comprising:
a second coupling layer positioned between the second electrode and the thermally sensitive element,
wherein the thermally sensitive element is in electrical communication with the second electrode via the second coupling layer.

26. The thermal sensor of claim 22, wherein the first and second arms, and the first and second support members hold the second electrode in spaced relation to a substrate.

27. The thermal sensor of claim 23, wherein the first and second arms, and the first and second support members hold the second electrode in spaced relation to a substrate.
